(19) United States
(12) Patent Application Publication
(10) Pub. No.: US 2005/0262771 A1
(43) Pub. Date: Dec. 1, 2005

(54) Window and door sub-sill and frame adapter and method of attaching a sill

(76) Inventor: Christopher A. Gorman, Ft. Lauderdale, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(21) Appl. No.: 10/859,447

(22) Filed: Jun. 1, 2004

(51) Int. Cl. E06B 7/14

(52) U.S. Cl. 49/408

(57) ABSTRACT

An apparatus and method for attaching a window or door sill to a building support structure is provided. The apparatus includes a rectangular frame that is attachable to a building support structure and provides an upper surface for a sill, to be securely attached to the apparatus. The apparatus thereby provides a raised surface with which to attach the sill. The apparatus includes a lip, which helps align the sill along the upper surface of the apparatus, and also helps prevent water intrusion. The apparatus further includes a support vein that runs through the center and along the length of the apparatus to provide added support strength.

### BACKGROUND OF THE INVENTION

1. Field of the Invention

The invention relates primarily to sliding-glass doors and windows in residential and commercial buildings. More specifically, the present invention is directed to securing a sliding-glass door or window to a building structure.

2. Description of the Related Art

Sliding-glass doors and windows are well known in the prior art. Both are popular in many homes, apartment buildings, condos, office buildings, and other similar structures. Sliding-glass doors and windows provide an aesthetically pleasing method of sealing the inside area of a structure from the outside environment while simultaneously allowing sunlight and warmth into a room. Sliding-glass doors have the added feature of also providing an easy method of entering or exiting a room.

A sliding-glass door is one in which one or more panels are moveable, one or more are normally fixed, and the bottom of each panel is provided with rollers. The panels sit in a doorframe, which includes two vertically orientated elongated elements disposed along either side of the rough opening of the door, an upper horizontally orientated element disposed along the top of the rough opening of the door, and a horizontally orientated element, called a “sill,” that is disposed at the bottom of the rough opening of the door. The sill is typically constructed of aluminum and has a raised rail or a groove for guiding the rollers along the length of the sill in a straight path. When lateral force is applied to one of the movable panels, the rollers travel along the rail or groove in the sill and allow the panel to easily move laterally along the length of the sill and create an opening where the panel was previously located.

The panels are typically disposed so that each panel overlaps an adjacent panel when opened. This arrangement allows the panels to move independently of one another. When in the closed position, the panels remain in a slightly overlapping configuration, thereby sealing the building from the outside elements. While one or more of the panels may be “fixed,” those panels are usually also equipped with rollers and have the ability to become “unfixed,” so that either panel can be moved if so desired.

Because sliding-glass doors form the barrier between the interior of a building and the outside world, it is important that the doors provide adequate protection against wind, rain, and other elements of the environment. The doorframe is an important part of this protection. Due to the severe pressures applied to the door by wind loads, the sill must be well secured to the floor. This is done by using masonry screws, which penetrate the sill and enter the concrete slab below the sill. In many states, building codes mandate the number and placement of the screws that must be used in each sill that is installed. For instance, the State of Florida currently requires at least 84 screws in a sixteen-foot-long sill. Because the prior-art method is to attach the sill directly to the concrete slab of the building, not only does the building code requirement necessitate the drilling of 84 holes in the sill and the concrete, it also requires the installer to drive 84 masonry screws directly into the concrete slab. Clearly, this is a very labor intensive and expensive process of installation. Furthermore, the interior of a slab contains infrastructure such as rebar, conduit, electrical boxes, etc. Driving screws into the slab presents the possibility of hitting any one of these infrastructural items. Accordingly, the more screws that have to be driven, the higher the probability of hitting the infrastructure. It is therefore desirable to find a device and method for being able to quickly and safely secure a door sill to a supporting structure of a building.

Additionally, a sill must prevent water from intruding into the interior of a building. It is desirable for the sill to be constructed so as to block the flow of water and to simultaneously provide a water runoff path for any water that does intrude upon the sill. As stated in the preceding paragraph, prior-art sills are attached directly to the concrete slab. This arrangement places the sill at ground level, allowing water to quickly overcome the sill and flow into the building. This problem is aggravated by the placement of flooring material, such as ceramic tile, outside the sliding-glass door and near the sill. The tile raises the floor level next to the sill, and accordingly, water can more easily overcome the sill.

Sills are commonly provided with a “weeping” mechanism, which allows water entering the channel of the sill to drain through a multitude of small holes, which exit the sill at its base. The placement of flooring material against the sill substantially blocks the weeping holes and prevents proper drainage from the sill.

Another problem with prior art sills is that the underside of the sill does not present a flat surface. This presents a problem when the building structure that they are to be installed upon is not flat and/or smooth. For the sill to properly guide the sliding doors, the sill must be level. One method of leveling and supporting the sub-sill is to place a bed of grout in the track, or mounting surface, under the sub-sill. The grout is a sandy composition that must be mixed with water and then poured into the mounting surface. The grout messy, requires two components, is hard to work with, and drying time must be added to the installation process. Shims can be inserted between the sill and the mounting surface to level the sill. The shims may be made from plastic, wood, or other types of construction material. If the bottom of the sill does not present a flat surface to rest upon the shim, shimming is difficult and sometimes ineffective. Placing a shim under a sill that has only a small support surface causes the sill to be supported in a single area. Because the support is not distributed along the sill, the sill will sag on either side of the support area and result in a wavy sill. As the rollers of the door travel along the sill, they will encounter areas of resistance as they attempt to climb the peaks of the sill at the supported areas. Adding to this problem is the fact that many states have begun requiring impact resistant sliding glass doors. These doors are over three times the weight of traditional sliding glass doors. The resistance encountered by the heavier doors in a wavy track can be substantial. It is therefore desirable to find a device and method for easily leveling a sill, while distributing the support along the sill, during installation.

### SUMMARY OF THE INVENTION

It is accordingly an object of the invention to provide an apparatus and method for securing a door or window sill to a supporting structure of a building, while utilizing fewer screws than the prior-art method and resulting in a sill that is superior in strength and water prevention capability.

In particular, it is an object of the invention to provide a sub-sill that is quickly and easily attachable to a concrete slab of a building and provides a way of quickly and easily securing a sill to the sub-sill while reducing the possibility of interfering with cables and/or rigid elements within the concrete slab or any other building structures. It is a further object of the invention for the sub-sill and sill combination to withstand heavy wind loads against the door or window and resist water intrusion into the inside area of the building.

While the object of the invention is to secure doors, windows, or any similar structures, the remainder of the specification will refer only to sub-sills for sliding-glass doors commonly known and used by those with skill in the art of construction.

With the foregoing and other objects in view, there is provided, in accordance with the invention, an elongated, rectangular shaped sub-sill having an upper wall, a lower wall, and two side walls. One side wall is taller than its opposing side wall and extends beyond the surface of the upper wall. As will be discussed, the taller side wall forms a lip that prevents water intrusion.

The sub-sill is installed so that the outer surface of the lower wall makes contact with the floor, or other supporting structure of the building. The taller side wall faces the interior of the building. In that configuration, the upper surface of the sub-sill provides a solid flat surface for the attachment of a sill. Typically, flooring material, such as tile, will be installed on deck or patios outside of a building. The height of the sub-sill is selected so that the upper surface of the adjacent flooring material will be approximately even with the upper wall of the sub-sill. When the sill is secured to the sub-sill, it will be positioned above the surface of the adjacent flooring material. This will help prevent water on the surface of the flooring material from running across the sill and into the interior of the building. Further moisture protection is provided by the taller side wall of the sub-sill, which presents a lip. The lip will help prevent any moisture present on the upper surface of the upper wall of the sub-sill from entering the building. Additionally, the flooring material no longer prevents water run-off from the sill/sub-sill combination, because the weep holes are higher than the flooring material and can actually flow onto the flooring material instead of trying to flow under it. This structure has the advantage of protecting the interior from a much higher level of flooding than do the prior art sills.

The sub-sill is to be constructed of a ridged material so that substantial amounts of pressure on the attached sill will not distort the sub-sill below. The ridged material is preferably aluminum or some other metallic composition, but other materials may also suffice for its intended use. The amount of load a sill must withstand is defined by local building codes or the specifics of its intended use. The material selected for the sub-sill may be a product of the particular building code where the building is to be erected, or may simply be a cost/benefit choice of the builder. Another consideration when choosing the material is the material's ability to withstand rust, rotting, or other types of degradation over time. For this reason also, aluminum is a preferred choice of material.

Because of the above-described construction, a sill attached to the inventive sub-sill, which is itself anchored to the building structure, can handle loads much greater than that of prior-art sills attached directly to a structure. Part of the reason for this is that the sub-sill can accommodate larger masonry screws than those used with prior-art sills. The most common building structure for mounting sills is a concrete slab. Because drilling and screwing into concrete is a laborious task, reducing the number of times necessary to perform this task is a great benefit to the installer. Because of the added strength provided by the structure of the sub-sill and the larger screws, the sub-sill can be attached to the concrete with fewer screws than is required by current building codes for prior-art sills installed directly to the slab. In the case of the present invention, the sill is attached directly to the sub-sill. This provides an advantage over prior-art structures because it is now only necessary to penetrate the relatively thin upper wall of the sub-sill to securely anchor the sill. This overall structure uses fewer screws than the prior-art method. This advantageous construction converts to time and cost savings during installation, which can become significant, especially during installation of multiple sills in a single structure.

In accordance with an additional feature of the invention, a vein can be added, which runs through the interior of the sub-sill to provide structural support. The vein can vary in position and thickness, but generally acts as a third wall and runs the length of the sub-sill and connects the upper wall to the lower wall. The vein is located between the first and second side walls.

In accordance with yet another feature of the invention, the sub-sill can be pre-drilled when manufactured, thereby facilitating installation by requiring the installer to drill only into the building structure upon which the sub-sill is to be attached.

In accordance with one more feature of the invention, the sub-sill can be provided in stock lengths.

Although the invention is illustrated and described herein as embodied in an apparatus and method for attaching door and window sills to supporting structures, it is nevertheless not intended to be limited to the details shown, since various modifications and structural changes may be made therein without departing from the spirit of the invention and within the scope and range of equivalents of the claims.

The construction and method of using the invention, however, together with additional objects and advantages thereof will be best understood from the following description of the specific embodiment when read in connection with the accompanying drawings.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a fragmentary, diagrammatic, front-elevational view of a sliding glass door assembly mounted in an opening of a building or other type of structure;

FIG. 2 is a fragmentary, enlarged, cross-sectional view of a sill mounted on a concrete slab;

FIG. 3 is a further enlarged, perspective view of a sub-sill;

FIG. 4 is a perspective view of a sub-sill mounted on a building structure;

FIG. 5 is a sectional view of a sliding glass door mounted on a sill, which is, in turn, mounted on the sub-sill, which is itself mounted on a building structure; and

FIG. 6 is a further enlarged, perspective view of a double-height sub-sill.

### DESCRIPTION OF THE PREFERRED EMBODIMENTS

While the specification concludes with claims defining the features of the invention that are regarded as novel, it is believed that the invention will be better understood from a consideration of the following description in conjunction with the drawing figures, in which like reference numerals are carried forward.

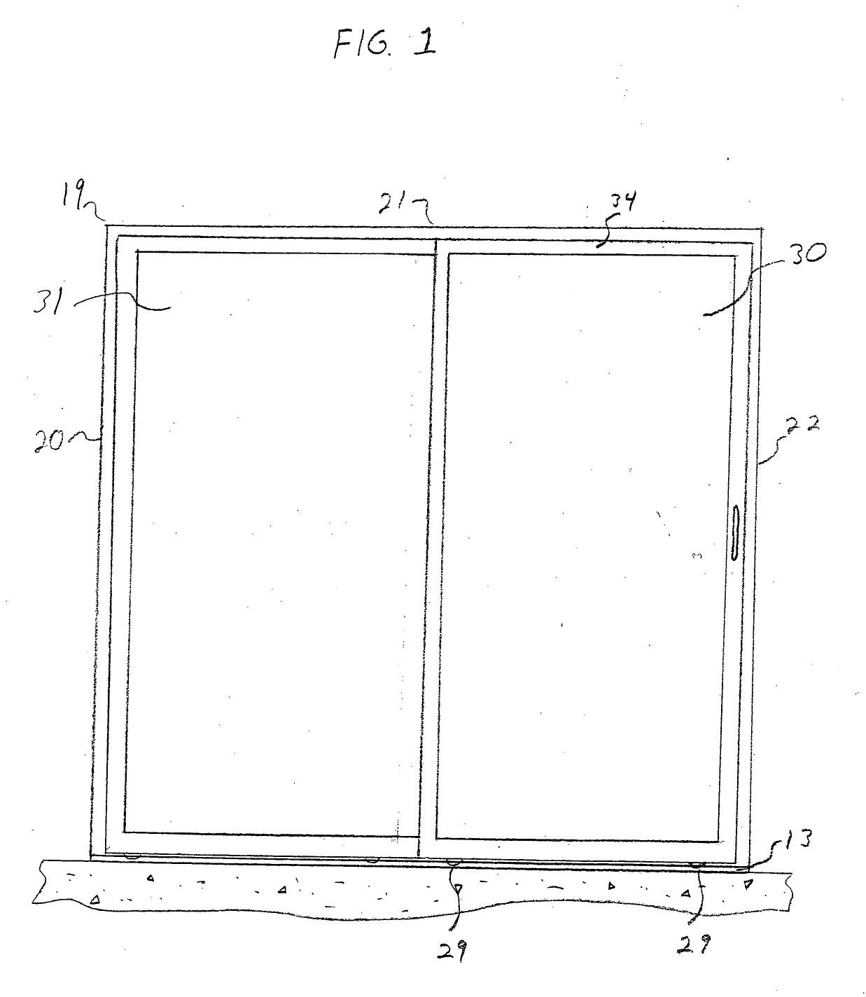

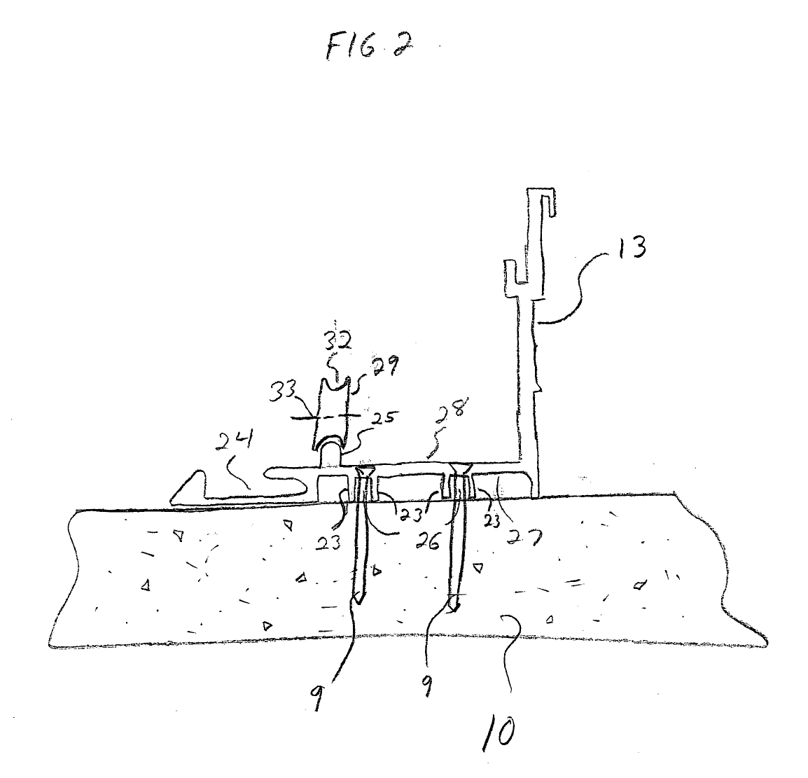

Referring now to the figures of the drawings in detail, and in particular to FIG. 1, there is illustrated a door frame 19 having elements 20, 21, 22, and sill 13. Elements 20, 21, and 22 are elongated hollow bodies having opposing wall elements which are disposed inwardly toward door panels 30 and 31 and form a U-shaped channel in which door panels 30 and 31 are seated. A cross-sectional view of the fourth frame element, sill 13, can be seen in FIG. 2. Sill 13 is generally constructed from aluminum. The underside 27 of sill 13 has downwardly extending opposing sets of walls 23, which define cavities 26. Cavities 26 present channels in which masonry screws 9 pass through an upper side 28 of the sill 13 and into the mounting surface 10 upon which the sill is to be installed. Sill 13 is formed with a channel 24, constructed to accept a member (not shown) for preventing water intrusion. Sill 13 is also provided with a ridge 25, which extends laterally along the entire length of the sill 13.

Overlapping doors 30 and 31 are shown in FIG. 1. Door 30 is provided with rollers 29 at its bottom edge. The rollers 29 are rotatable around a center axis 33 and have a concaved circumferential edge 32. When lateral force is applied to door 30, roller 29 rotates around axis 33, concaved edge 32 follows ridge 25 along a length of sill 13, and door 30 is easily displaced. It should be noted that door panel 31 can also be provided with rollers and sill 13 can be provided with an additional ridge, thereby allowing panel 31 to be easily displaced with an applied lateral force similar to door panel 30. Door panels 30 and 31 are further guided by the above-mentioned channel in frame element 21, located directly above the door panels 30 and 31. For example, as door panel 30 travels laterally along the ridge 25 of sill 13 on rollers 29, the upper portion 34 of door 30 rides along inside the channel of frame element 21, thereby preventing the door panel 30 from moving away from frame element 21, but instead allowing it to only move along the length of frame element 21.

As is shown in FIG. 2, the sill 13 is attached to a concrete slab 10 with masonry screws 9. To properly install a sill 13, an installer must place the sill onto the slab 10, drill the requisite number of pilot holes into the concrete slab 10, and then turn each masonry screw 9 until it is properly seated and the sill 13 is secure. Under several current building codes, a minimum of 84 masonry screws must be installed in a 12′ sill. The code is written to provide sufficient protection against shear forces acting upon the door or window. Shear forces are those forces that cause or tend to cause two contiguous elements to slide relative to each other in a direction parallel to their plane of contact. The present invention facilitates use of larger size screws than are used in the prior art and therefore allows a sill 13 to be securely installed onto a concrete slab 10 using fewer screws 9 and, accordingly, fewer holes need be drilled and the installation expense is greatly reduced.

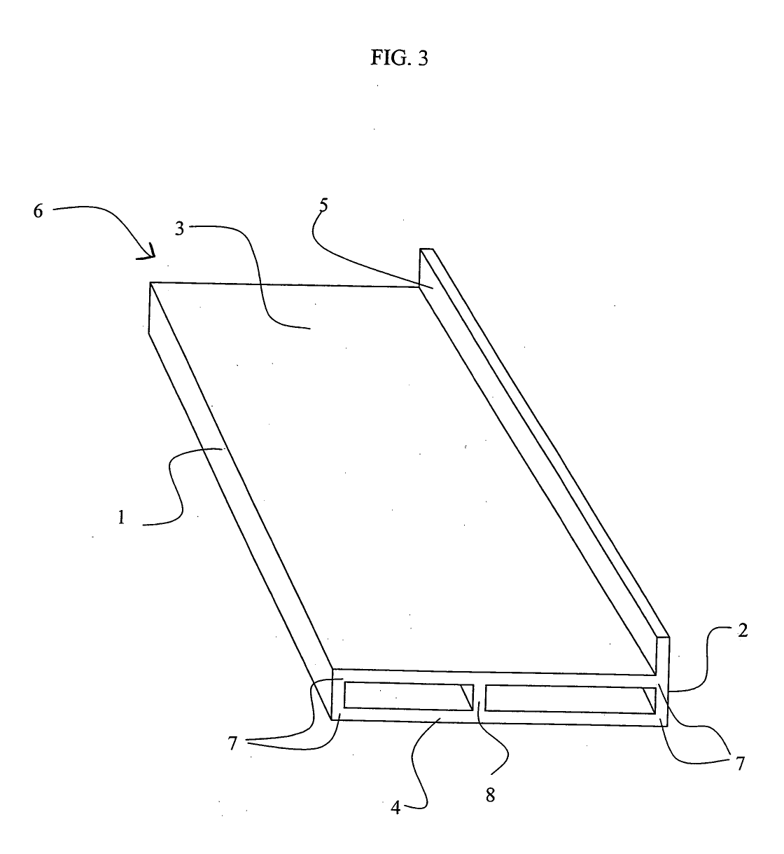

FIG. 3 shows a sub-sill 6 in accordance with the preferred embodiment of the present invention. The sub-sill 6 has an elongated hollow rectangular body, formed of a first side wall 1 opposite and parallel to a second side wall 2, both the first 1 and second 2 side walls being attached to, and perpendicular to an opposing upper wall 3 and a lower wall 4. Upper wall 3 and opposing lower wall 4 are parallel to one another. As can be seen in the figure, the second side wall 2 extends beyond the point where upper wall 3 is joined to the second side wall 2. The portion of second side wall 2 extending above upper wall 3 creates a lip 5.

The walls 1, 2, 3, 4 can be joined in a variety of ways. A preferable method of joining the walls 1, 2, 3, and 4 is by making use of an extrusion process. For instance, if aluminum is the chosen material, hot liquid aluminum can be continuously pushed through a mold and then cooled. In this way, as shown in FIG. 3, the resulting sub-sill 6 is one continuous piece of aluminum and, advantageously, is sealed at all wall junctions 7.

Although an extrusion process has been described, many materials and techniques may be used to join the walls 1, 2, 3, and 4 to one another. For instance, the sub-sill can be constructed from a variety of synthetic or metallic compounds, provided the chosen material will withstand sufficient loads placed upon the sub-sill. The walls 1, 2, 3, and 4 can be connected with adhesive, a locking system, or a variety of other techniques. It should be noted that it is desirable, but not necessary, for the walls 1, 2, 3, and 4 to be connected in a waterproof manner.

To increase the load-bearing strength of the sub-sill 6, as shown in FIG. 3, a support vein 8 can be added. Support vein 8 is located between the first wall 1 and the second wall 2 and connects the lower wall 4 to the upper wall 3. The support vein 8 acts as a support wall does in common building construction and can significantly increase the strength of the sub-sill. The support vein 8 can be easily manufactured into the sub-sill via the extrusion process described above.

Once installed, the ends 44, 46 of the sub-sill 6 will be sealed with construction materials or blocked by the walls defining the rough opening in the building into which the sub-sill will be installed. Moisture may penetrate the interior of the sub-sill 6 through holes 11 or other areas of the sub-sill. To allow moisture to escape from within the sub-sill 6, optional weep holes 42 can be provided in the side 1 and support vein 8 of the sub-sill 6. The weep holes 42 can either be predrilled at the time of manufacturing or drilled in the field at the time of installation.

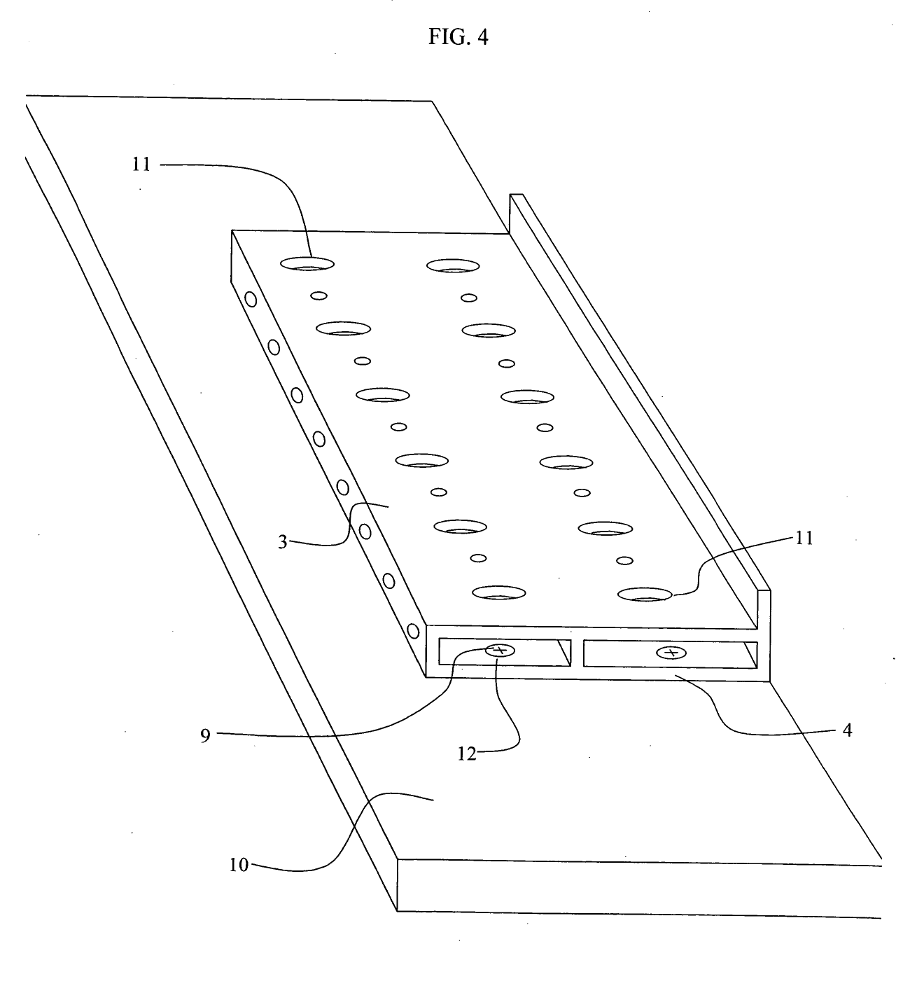

Because the sub-sill must be securely fastened to the building support structure, a method of fastening must be utilized. Although many options are available, one preferred method of fastening is through the use of masonry screws. As shown in FIG. 4, masonry screws 9 extend through lower wall 4 of sub-sill 6 and penetrate into the building structure 10. Tightening masonry screws 9 causes the head of masonry screws 9 to place downward pressure on lower wall 4, and upward pressure is placed on building structure 10 by the threads of masonry screws 9. Masonry screws 9 are easily inserted and tightened by use of pre-formed holes 11 in upper wall 3 and smaller pre-formed holes 12 in lower wall 4. Holes 11 allow the masonry screws 9 to be inserted into holes 12 and allow a tightening tool to access the masonry screws 9 during installation of the sub-sill. Although a method of screwing the sub-sill to the building structure has just been described, other methods may be used which produce a similarly secure connection.

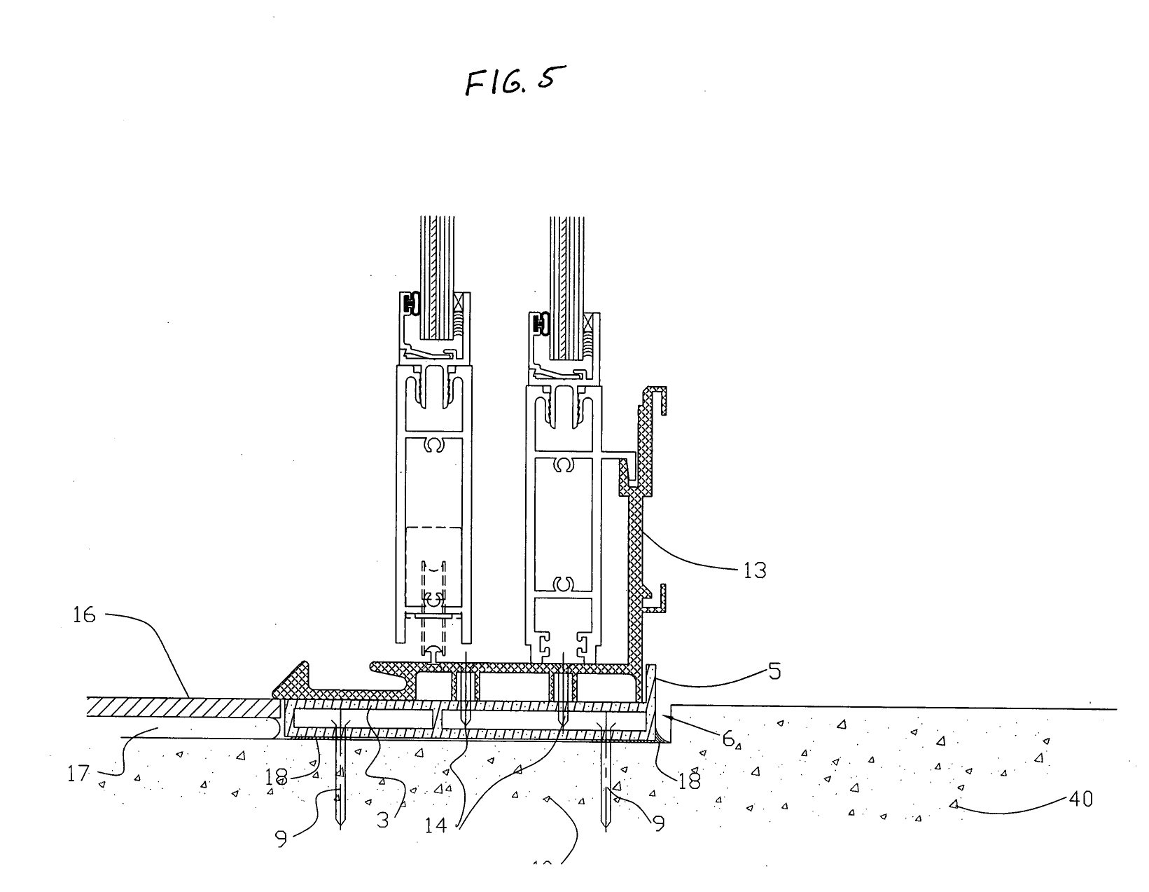

Once the sub-sill is secured to the building structure, a sill can then be attached to the sub-sill. A preferable method of attachment is through the use of screws. As shown in FIG. 5, a sill 13 is placed above sub-sill 6 and pushed against lip 5 of sub-sill 6. Lip 5 is used at this stage to properly align the sill 13 along sub-sill 6. Once sill 13 is properly seated along the lip 5 of sub-sill 6, it is then securely attached to sub-sill 6 through use of screws 14. Using the prior art method, screws 14 would have to be screwed into concrete 10 to secure sill 13. However, the present invention provides the advantage of only requiring the screws 14 to penetrate the relatively thin upper wall 3 of sub-sill 6. This step can be made even easier by forming, or pre-drilling, pilot holes 40 (shown in FIG. 4) into upper wall 3 at the time of manufacturing, thereby allowing the sill installer to simply align the screws 14 with the holes and tighten, which eliminates a drilling step.

The prevention of moisture intrusion is an important function of a door sill. Not only does the present invention facilitate a much simpler and less expensive installation process than does the prior art, the invention also provides an improved method of preventing intrusion of moisture into the interior of a building. As is shown in FIG. 5, flooring material 16, such as tile, is frequently placed on the exterior of the building and is attached with a cement material 17. Water will naturally run across the flooring material 16 and toward the building. The present invention places the sill 13 at a greater height than the flooring material 16 and thereby advantageously places the sill above a level of water that might be standing on the surface of the flooring material 16. Without the sub-sill 6, water running off of the tile would easily flow onto the sill 13 and have a greater chance of entering the interior of the building. A further water-prevention feature is provided by lip 5. Lip 5 not only provides a convenient method of aligning the sill 13, it also provides an additional water barrier to prevent moisture intrusion into the interior of the building. Any water that finds its way onto the upper surface of upper wall 3 will be blocked from flowing into the interior of the building by the lip 5.

Further water protection can be provided by the placement of a layer of sealant 18, for instance silicone, between the support structure 10 and the sub-sill 6. The layer of sealant will prevent water from traveling under the sub-sill and reaching the interior of the building. Preferably, a layer of sealant 18 is placed on the support structure 10 and, before the sealant 18 has dried, the sub-sill 6 is placed into the sealant 18 and secured to the floor 10. Placing the sub-sill 6 in the moist sealant 18 will allow the sealant to flow out and thereby remove all pockets of air, creating a waterproof seal between the sub-sill 6 and the substrate or floor 10.

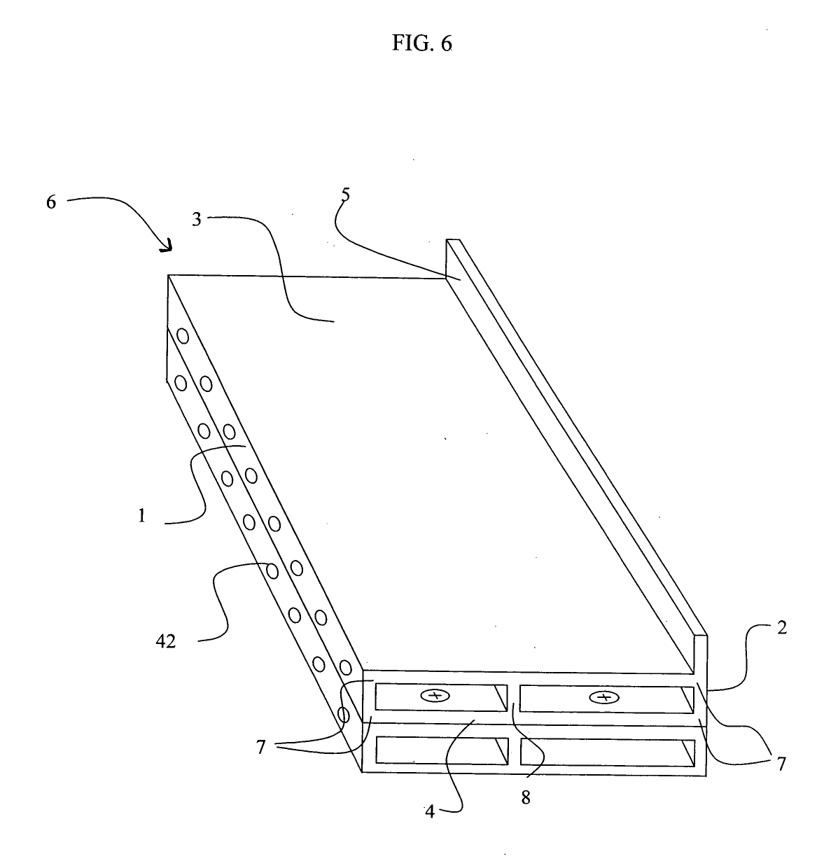

FIG. 6 shows a sub-sill 6 in a double-height configuration. The double-height provides the advantage of placing the upper surface 3 at a greater height above the outer flooring surface 16, adding greater water penetration prevention ability to the sub-sill 6. In addition, outer wall 1 and support vein 8 of both sections can be provided with weep holes 42 to facilitate water removal from within the sub-sill.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. In a sliding glass door or window assembly, having at least one movable door located on a sill secured to a building structure, the improvement comprising:
a sub-sill disposed between the sill and the building structure, said sub-sill including:
a first side wall having a first end and a second end;
a second side wall having a first end and a second end;
an upper wall connecting said first end of said first side wall to said first end of said second side wall;
a lower wall connecting said second end of said first side wall to said second end of said second side wall; and
a lip extending from said upper wall in a direction away from said lower wall, and located at said second end of said upper wall.

2. The sub-sill according to claim 1, wherein said first side wall is parallel to said second side wall.

3. The sub-sill according to claim 1, wherein said upper wall is parallel to said lower wall.

4. The sub-sill according to claim 1, wherein said upper and said lower walls are perpendicular to said first and second side walls.

5. The sub-sill according to claim 1, further comprising:
at least one support vein located between said first and said second walls, connecting said upper and said lower walls.

6. The support vein according to claim 5, further comprising:
a plurality of openings provided in and penetrating through the support vein to facilitate water drainage.

7. The sub-sill according to claim 1, wherein said sub-sill is constructed of a metallic material.

8. The sub-sill according to claim 1, wherein said upper wall and said lower wall are provided with pre-drilled holes.

9. The sub-sill according to claim 1, wherein:
said side walls are joined to said upper and said lower walls with a continuous, water-proof connection.

10. The sub-sill according to claim 1, further comprising:
a plurality of openings provided in and penetrating through at least one of the side walls to facilitate water removal.

11. A method for attaching a sill to a support structure of a building, the method comprising:
providing a sub-sill including:
a first side wall having a first end and a second end;
a second side wall having a first end and a second end;
an upper wall connecting the first end of the first side wall to the first end of the second side wall;
a lower wall connecting the second end of the first side wall to the second end of the second side wall; and
a lip extending from the upper wall in a direction away from the
lower wall, and located at the second end of the upper wall, placing the sub-sill along a section of a building structure;
attaching the lower wall of the sub-sill to the building structure; and
attaching a sill to the upper wall of the sub-sill.

12. The method according to claim 11, further comprising placing shim material under the sub-sill to ensure the upper wall of the sub-sill is level.

13. The method according to claim 11, further comprising attaching the sub-sill to the building support structure and the sill to the sub-sill with screws.

14. The method according to claim 11, further comprising arranging the sub-sill so that the second side wall is closer to the interior of the building than is the first side wall.

15. The method according to claim 11, further comprising placing a bed of sealant between the support structure and the sub-sill.

16. A sub-sill for securing a sill, comprising:
a first side wall having a first end and a second end;
a second side wall having a first end and a second end;
an upper wall connecting said first end of said first side wall to said first end of said second side wall;
a lower wall connecting said second end of said first side wall to said second end of said second side wall;
a lip extending from said upper wall in a direction away from said lower wall, and located at said second end of said upper wall; and
at least one support vein located between said first side wall and said second side wall and connecting said upper wall to said lower wall.

17. The sub-sill according to claim 16, further comprising a plurality of holes located in said upper wall for accepting screws.

18. The sub-sill according to claim 16, further comprising a plurality of holes located in said lower wall.

19. The sub-sill according to claim 16, wherein said first side wall is parallel to said second side wall.

20. The sub-sill according to claim 16, wherein said upper wall is parallel to said lower wall.

21. The sub-sill according to claim 16, wherein said upper and said lower walls are perpendicular to said first and second side walls.

22. The sub-sill according to claim 16, wherein said sub-sill is constructed of a metallic material.

23. The sub-sill according to claim 16, wherein:
said side walls are joined to said upper and said lower walls with a continuous, water-proof connection.

24. The support vein according to claim 16, further comprising:
a plurality of openings provided in and penetrating through the support vein to facilitate water drainage.

25. The sub-sill according to claim 1, further comprising:
a plurality of openings provided in and penetrating through at least one of the side walls to facilitate water removal.
